(19) United States
(12) Patent Application Publication
(10) Pub. No.: US 2015/0079986 A1
(43) Pub. Date: Mar. 19, 2015

(54) System and Methods for Optimizing Service Acquisition From Power Save Mode on a Multi-SIM Device

(71) Applicant: QUALCOMM Incorporated, San Diego, CA (US)

(72) Inventors: Shivank Nayak, San Diego, CA (US); Karthik Nagpal Bengoti Vuchula, Hyderabad (IN); Rajesh Madhukar Patil, Hyderabad (IN)

(21) Appl. No.: 14/332,441

(22) Filed: Jul. 16, 2014

(30) Foreign Application Priority Data
Sep. 13, 2013 (IN) 4128/CHE/2013

(51) Int. Cl. H04W 48/18; H04W 52/38

(52) U.S. Cl. CPC H04W 48/18; H04W 52/386
USPC 455/435.2

(57) ABSTRACT

Methods, devices, and systems embodiments enable efficient service acquisition on multiple subscriber identification modules (SIMs) of a multi-SIM wireless device. A processor may determine whether the first SIM has acquired a first service with a first wireless network while the second SIM is operating in a second SIM deep sleep period. The processor may also trigger the second SIM to operate in an awake state, prior to expiration of the second SIM deep sleep period, to acquire a second service with a second wireless network in response to determining that the first SIM has acquired the first service with the first wireless network.

### RELATED APPLICATIONS

This application claims the benefit of priority to Indian Patent Application No. 4128/CHE/2013 entitled “System and Methods for Optimizing Service Acquisition From Power Save Mode on a Multi-SIM Device” filed Sep. 13, 2013, the entire contents of which are hereby incorporated by reference for all purposes.

### BACKGROUND

Wireless communication devices may undergo various system acquisition processes in attempting to connect to a system after initial power up or loss of service. For example, a wireless device may scan the air interface/local wireless environment for radio frequencies corresponding to particular networks. For example, a wireless device may scan the local wireless environment to detect radio frequencies corresponding to particular networks, and select suitable cells in those networks based on any of a number of prioritization factors (e.g., recency of use, preference set forth by the service provider, etc.). In a typical arrangement, a device may store a list of networks set by the service provider, a list of frequency bands supported by the device, and a list of channels within each supported band.

Wireless communication devices including more than one subscriber identification module (SIM), also known as “multi-SIM wireless devices,” have become increasing popular because of the flexibility in service options and other features such multi-SIM wireless devices provide. One type of multi-SIM wireless device, a dual-SIM dual-active (DSDA) device, allows simultaneous active connections with the networks corresponding to two SIMs. DSDA devices typically have separate baseband modem-radio frequency (RF) resource chains associated with each SIM. Another type of multi-SIM wireless device, a dual-SIM dual-standby (DSDS) device, shares a common RF resource between both SIMs, generally allowing selective communication on a first network while listening for pages on a second network. Further, multi-SIM devices may have more than two SIMs (e.g., tri-SIM, quad-SIM, etc.). For example, another type of multi-SIM wireless device, a tri-SIM tri-standby (TSTS) device, may share a common RF resource between all three SIMs, allowing selective communication on a first network while listening for pages on a second network and a third network.

In various types of multi-SIM devices, each modem stack may independently perform a service acquisition procedure, including scanning the local wireless environment for channels associated with various networks/systems. As a result, recovery and/or startup time may be prolonged and a large amount of power may be consumed. Typically, modem stacks associated with out-of-service SIMs may employ a power save mode in which the modem stack associated with each out-of-service SIM may cycle between periods of attempting to acquire full or limited service on a wireless network, and low power sleep periods that may incrementally increase in duration. A short sleep period and/or a long awake period may be selected for potentially faster service acquisition with higher battery power consumption. Conversely, a long sleep period and/or a short awake period may be selected for longer battery life with potentially slower service acquisition. Thus, while the power save mode may provide power savings and introduce some efficiency, a trade-off still exists between the durations of low power sleep periods and the speed at which service may be acquired on the SIMs.

### SUMMARY

Methods, devices, and systems of various embodiments enable a multi-SIM wireless device having a first SIM and a second SIM to acquire wireless network service. Various embodiments may include a processor of the multi-SIM wireless device determining whether the first SIM has acquired a first service with a first wireless network while the second SIM is operating in a second SIM deep sleep period. The processor may trigger the second SIM to operate in an awake state, prior to the expiration of the second SIM deep sleep period, to acquire a second service with a second wireless network in response to determining that the first SIM has acquired the first service with the first wireless network while the second SIM is operating in the second SIM deep sleep period.

In some embodiments, determining that the first SIM has acquired the first service with the first wireless network may include the first service being a most recently lost service of the first SIM and/or a limited service. The second SIM may be determined to be operating in the second SIM deep sleep period as part of a second SIM power save mode. The processor may trigger the second SIM to operate in an awake state to acquire the second service with the second wireless network while maintaining the second SIM in the second SIM power save mode unless the second service is acquired. The second SIM deep sleep period may be part of a second SIM power save mode that includes a second SIM first sleep cycle and a second SIM second sleep cycle. One of the second SIM first sleep cycle and the second SIM second sleep cycle may not include a second SIM awake period. The processor may determine that the first SIM has acquired the first service with the first wireless network in response to the first SIM waking from a first SIM deep sleep period.

In some embodiments, operating in a deep sleep period (i.e., a first SIM deep sleep period or a second SIM deep sleep period) may include refraining from attempting acquisition of service and shutting down non-essential circuitry associated with the SIM. A SIM may operate in a deep sleep period as part of being set to operate in a power save mode (i.e., a first SIM power save mode or a second SIM power save mode). A power save mode may include a deep sleep period and an awake period. A SIM searching for service during an awake period may find service and connect to a wireless network, which may trigger the second SIM to operate in an awake state. The awake period of one SIM may not overlap in time with the awake period of another SIM. A duration of the first SIM deep sleep period and the second SIM deep sleep period may be based on how long the respective first SIM and second SIM have been out-of-service.

In some embodiments, the second SIM may be set to operate in a second SIM power save mode, including the second SIM deep sleep period and a second SIM awake period, in response to determining that the second SIM is out-of-service. The first SIM awake period and the second SIM awake period may be interleaved so they do not overlap in time. The second SIM may be set to operate in a second SIM power save mode, including the second SIM deep sleep period, in response to determining that the second SIM is out-of-service. There may be at least a partial overlap in time during which the first SIM operates in the first SIM power save mode and the second SIM operates in the second SIM power save mode. The first SIM power save mode may include a first SIM first sleep cycle and a first SIM second sleep cycle. The first SIM second sleep cycle may not include the first SIM awake period. In addition, the second SIM power save mode may include a second SIM first sleep cycle and a second SIM second sleep cycle. The second SIM second sleep cycle may not include a second SIM awake period. The first SIM second sleep cycle and the second SIM second sleep cycle may not overlap in time.

In some embodiments, triggering the first SIM to operate in an awake state to acquire the second service with the first wireless network may include detecting a first service signal and attempting to acquire full service using the first service signal. A processor may determine whether full service was acquired using the first service signal. In response to determining that full service was not acquired using the first service signal, a second service signal may be detected and an attempt may be made to acquire limited service using the second service signal. In addition, triggering the second SIM to operate in an awake state to acquire the second service with the second wireless network may include detecting a service signal of a most recently lost service of the second SIM corresponding to the second wireless network. The second SIM may connect to the second wireless network using the service signal. The second service may be acquired for the second SIM with the second wireless network in response to triggering the second SIM to attempt to acquire the second service to the second wireless network. The first SIM may be determined to have acquired the first service with the first wireless network while the second SIM is operating in the second SIM deep sleep period. This determination may include determining whether the second SIM is operating in the second SIM deep sleep period.

In some embodiments the multi-SIM wireless device may include a dual-SIM dual-standby (DSDS) device, a tri-SIM tri-standby (TSTS) device or a dual-SIM dual-active (DSDA) device in which a processor is configured to perform the operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a wireless network block diagram according to various embodiments.

FIG. 2 is a block diagram illustrating a dual-SIM wireless device according to various embodiments.

FIG. 3 is a block diagram illustrating example protocol layer stacks in a dual-SIM wireless device according to various embodiments.

FIGS. 4A and 4B illustrate representative timelines showing optimized service acquisition from power save mode on a dual-SIM wireless device according to various embodiments.

FIG. 5 is a process flow diagram illustrating a method for optimized service acquisition in a dual-SIM wireless device in power save mode according to various embodiments.

FIG. 6 is a component diagram of an example wireless device suitable for use with various embodiments.

FIG. 7 is a component diagram of another example wireless device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “wireless device,” “wireless communication device,” and “mobile device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “SIM”, “SIM card,” and “subscriber identification module” are used interchangeably to mean a memory that may be an integrated circuit or embedded into a removable card, which stores an International Mobile Subscriber Identity, related key, and/or other information used to identify and/or authenticate a wireless device on a network. The information stored in a SIM enables the wireless device to acquire service from a particular network. As used herein, the terms “wireless network service” or simply “service” are used interchangeably to describe user-information transfer capabilities provided through an established connection between a wireless device and a wireless network. For example, service may include voice telephone calls, video conferencing, email or text messaging, and data transfers, such as multi-media exchanges. The process of “acquiring service,” “acquisition of service,” or “service acquisition” interchangeably refer to establishing a communication connection for service associated with a subscription provided by a particular wireless network. Thus, a SIM may be correlated to a particular wireless network, for providing service associated with a subscription. A SIM has “acquired service” (i.e., “acquired a first service” or “acquired a second service”) with the wireless network upon establishment of a connection for actively communicating with the wireless network or, if active communication is not required, operating in idle mode while camping on the wireless network.

As used herein, the terms “multi-SIM device,” “multi-SIM wireless device” “dual-SIM device” “dual-SIM dual active device” and “DSDA device” are used interchangeably to describe a wireless device that is configured with more than one SIM and is capable of independently handling communications with networks of all subscriptions.

As used herein, the terms “wireless network,” “cellular network,” “public land mobile network,” and “PLMN” are used interchangeably to describe a wireless network of a carrier associated with a wireless device and/or subscription on a wireless device, and/or its roaming partners.

As used herein, the terms “cell” and “base station” are used interchangeably to describe a base transceiver station, radio base station, or node from which a network operator broadcasts communication channels that advertise the network's presence, operator identity, and/or other necessary initial information for receivers to acquire service.

In recent years, use of mobile devices using wireless network service has become commonplace, among mobile professionals and throughout the more general consumer population. To support broad customer's efficient acquisition of wireless network service, many mobile devices today are capable of using various networks and even different network technologies in many different regions, and increasingly, in different countries.

Wireless network systems are widely deployed to provide various services such as voice, video, packet data, messaging, broadcast, etc. These wireless network systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems. Further, for the efficient acquisition of wireless network service, wireless service carriers have standardized a number of techniques for selecting wireless network systems in geographic regions and obtaining service there from, in accordance with preferences of the subscriber's service provider/carrier. The local wireless network systems may also support different multiple-access wireless communications protocols such as code division multiple access (CDMA), wideband CDMA (WCDMA), Advanced Mobile Phone Service (AMPS), Global System for Mobile communications (GSM), General Packet Radio Services (GPRS) or High Data Rate (HDR) technology (e.g., 1×EV technology).

A wireless device, such as a multi-SIM device, may be able to receive service from one or more wireless networks. Upon initial power up or following a loss of service on a modem stack(s) associated with a subscription(s), a wireless device may be out-of-service on one or more SIMs. As a result, the wireless device may attempt to connect with wireless networks that are able to provide service on the out-of-service SIM(s) by searching for service signals. As used herein, the term “service signal” refers to a beacon signal (i.e., pilot signal/base frequency signal) or other signal that may be broadcast by, and used to connect to, a particular base station of a communication network. If the processor of the wireless device detects a service signal for a wireless network channel for which the processor had initiated a search, then the processor may initiate registration of the wireless device with the wireless network to enable active communications with the network (e.g., voice/data calls) or to enable idle communications with the network (e.g., idle-standby-mode communications, such as page monitoring, power measurements, etc.) when active communications are not immediately needed/desired.

The wireless device may consume a large amount of battery power if the wireless device continuously searches for wireless networks while out-of-service on one or more SIMs. This heavy battery power consumption may significantly reduce both standby time and talk time, especially when the out-of-service duration is long. While the modem stacks associated with out-of-service SIMs may search for wireless networks infrequently in order to conserve battery power, infrequent searches may significantly delay service acquisition. Conventionally, this may be mediated by entering a power save mode that involves one or more sleep cycles for each SIM out-of-service for a prolonged period.

When the processor places the SIM in a power save, the SIM is referred to as “entering” the power save mode. The SIM may be maintained in the power save mode, repeating sleep cycles interspersed with awake periods to attempt to acquire service, until the SIM acquires service during an awake period of a particular sleep cycle. In response to the SIM acquiring service, the processor may remove the SIM from the power save mode, which is referred to as the SIM “exiting” the power save mode. A counter may be used to track the number of sequential cycles that occur while continuously in deep sleep mode. The counter may be reset when entering and/or exiting the power save mode. In various embodiments, in addition to removing the SIM from the power save mode in response to the SIM acquiring service, the processor may remove the SIM from the power save mode in response to determining that another SIM of the wireless device has acquired service.

A “sleep cycle” is used herein to refer to a cycle of operations that includes a deep sleep period and an awake period. In particular, the sleep cycle includes at least one duration of time in which the wireless device or stack may operate in a deep sleep state (this duration of time is referred to as a “deep sleep period”), and at least one other duration of time in which the wireless device or stack may operate in an awake state in which service acquisition may be attempted on a SIM (this other duration of time is referred to as an “awake period”). Each SIM may enter the power save mode separately and at different points in time, thus the respective sleep cycles corresponding to each SIM may also begin and end at different times. In this way, when more than one SIM is simultaneously out-of-service for a prolonged period, a first SIM deep sleep period of a first SIM may be staggered from a second SIM deep sleep period of a second SIM. The duration of the sleep cycles, awake periods, or deep sleep periods may be adjusted based on service conditions. For example, if the first SIM has been out-of-service for a long time, the sleep cycles, awake periods, or deep sleep periods may be extended or shortened.

During the deep sleep period, the wireless device or modem stack may power down some communications circuitry in order to conserve battery power. Various power save modes may provide for increasing the duration of the deep sleep period as the number of consecutive sleep cycles increases. For example, a sleep cycle may last for 30 seconds when the wireless device first enters a power save mode, may be longer (e.g., 45 seconds) after the wireless device has been in the power save mode for a number of sleep cycles, and may further increase until reaching a maximum duration (e.g., 60 seconds).

During the awake period, the processor of the wireless device may search for service signals in one or more frequency bands supported by a network operator or service provider that are associated with a SIM. The search for service signals may be performed by scanning channels in particular bands of the local wireless environment to detect service signals broadcasting appropriate identifiers. The particular bands (i.e., channels) to be scanned may be those associated with a SIM, and the channels may be all or a few specific frequency bands supported by a radio access technology. Alternatively, channels to be scanned may be those identified by accessing an acquisition database. As described, these scanning and search operations involved in a search for service signals increases power consumption on the wireless device.

During the awake period, the processor of the wireless device or stack may use an RF resource of the wireless device to perform a full service search and/or a limited service search. In a full service search, the SIM may select one or more channels to search based on user selection or based on a predefined order of priorities. Regarding the latter, the wireless device may be provisioned with a list of preferred channels or systems from which the wireless device may receive service in accordance with the predefined order of priorities. This preferred list may be referred to as a preferred PLMN list in Universal Mobile Telecommunications Systems (UMTS) or a preferred roaming list in other mobile technologies, such as CDMA2000. The preferred list may include a number of entries for particular wireless networks from which service may be received by the wireless device. For example, when a SIM has service but goes out-of-service, the channels for that most recently lost service may be maintained at the top of a preferred list for attempting service reacquisition. Each entry may include system identification information, frequency channel and band information, and/or other pertinent information used to acquire service with an associated wireless network. The system identification information may comprise a PLMN ID in UMTS, System Identification (SID) and Network Identification (NID) in CDMA2000, etc. The preferred list may be provisioned on the wireless device by a service provider with which the wireless device has a subscription. The preferred list may include a home system and other systems for which the service provider has roaming agreements. The preferred list may be stored in a SIM, a Universal SIM (USIM), or other non-volatile memory module.

A limited service search relates to services, such as emergency communication services, that provide limited data transfer/exchange capabilities. A limited service may not provide all of the features and/or functionality of full service, but may nonetheless be acceptable under various circumstances. If no suitable limited service channels are known or available, service acquisition need not include a search for limited service.

The processor of the wireless device or stack may detect a service signal on a channel for which the processor is attempting to acquire full service. In response to detecting that service signal, the processor may attempt to acquire full service. If the processor determines that full service was not acquired using that service signal, the processor may try to detect another service signal. If no more service signals for full service are available, the processor may resort to searching service signals for limited service. In this way, the processor of the wireless device or stack may detect another service signal on a different channel for which the processor is attempting to acquire limited service. If the processor determines that limited service was not acquired using that service signal, the processor may try other channels associated with acceptable limited service or return to deep sleep state by starting a deep sleep period for that SIM.

The processor of the wireless device or stack may attempt to camp a SIM on a suitable cell of the selected PLMN to maintain service. Camping on a suitable cell requires receiving and decoding an available and authorized signal from a cell that is broadcasting an ID of the selected PLMN. The signal may additionally need to allow for a radio path loss below a predetermined threshold. If no suitable cell is found for the selected PLMN (or any of the listed PLMNs in the predefined order of priorities), a limited service search may be performed in which acquisition of an acceptable cell with limited service is attempted on the SIM. Acquiring an acceptable cell may involve camping on any detected cell that is broadcasting a PLMN ID, regardless of the PLMN.

If the processor of the wireless device or stack is able to acquire service on a SIM (i.e., successfully camping the SIM on a suitable or acceptable cell for full or limited service, respectively), the modem stack may transition out of the power save mode and return to idle state (either in full or limited service). However, if service acquisition is unsuccessful, a processor may maintain the wireless device or stack in the power save mode.

In various multi-SIM devices, such as DSDA, DSDS, and/or TSTS devices, communications on each subscription may be implemented by separate modem stacks that each may perform independent service acquisitions according to preference data of the individual modem stacks. In multi-SIM devices that are configured with a shared RF resource, acquisition of service may necessarily be performed on each SIM one at a time, thereby prolonging service recovery time. In multi-SIM devices with separate RF resources for each SIM, acquisition scans may be performed simultaneously, a process that may consume a large amount of power in order to recover service on both SIMs.

In attempting to recover from being out-of-service, each stack may implement a power save mode in which the multi-SIM device limits the attempts to acquire service based on expiration of a timer. Since modem stacks operate independently for each SIM, power save modes may be implemented based on individual timer cycles tied to when the respective SIMs went out of service.

In various embodiments, service acquisition on multiple SIMs in power save mode may be improved by using the timing of out-of-service recovery on a first SIM. In particular, once a first SIM leaves a power save mode by successfully acquiring service, other SIMs in the same device may be alerted to immediately wake up and attempt service acquisition, thereby terminating the other SIMs' deep sleep period earlier than the other respective SIMs would have under normal timer expiration. For example, all of the SIMs of the multi-SIM device may be out-of-service because the device has been carried into a building or elevator, or has service otherwise obstructed. Thus, even though the multi-SIM device has not moved out of range of the particular cell(s) from which each SIM had lost service, all of the SIMs are out-of-service due to the obstruction. When the user exits the building or elevator or the obstruction is otherwise gone, the most recently lost service for all the SIMs may be readily available. However, due to the staggered sleep cycles, one of the SIMs is likely to remain in a deep sleep state longer than necessary. Thus, after one of the SIMs reacquires a most recently lost service with a particular wireless network, the processor may trigger the other SIM to wake up to attempt to reacquire the most recently lost service with its wireless network.

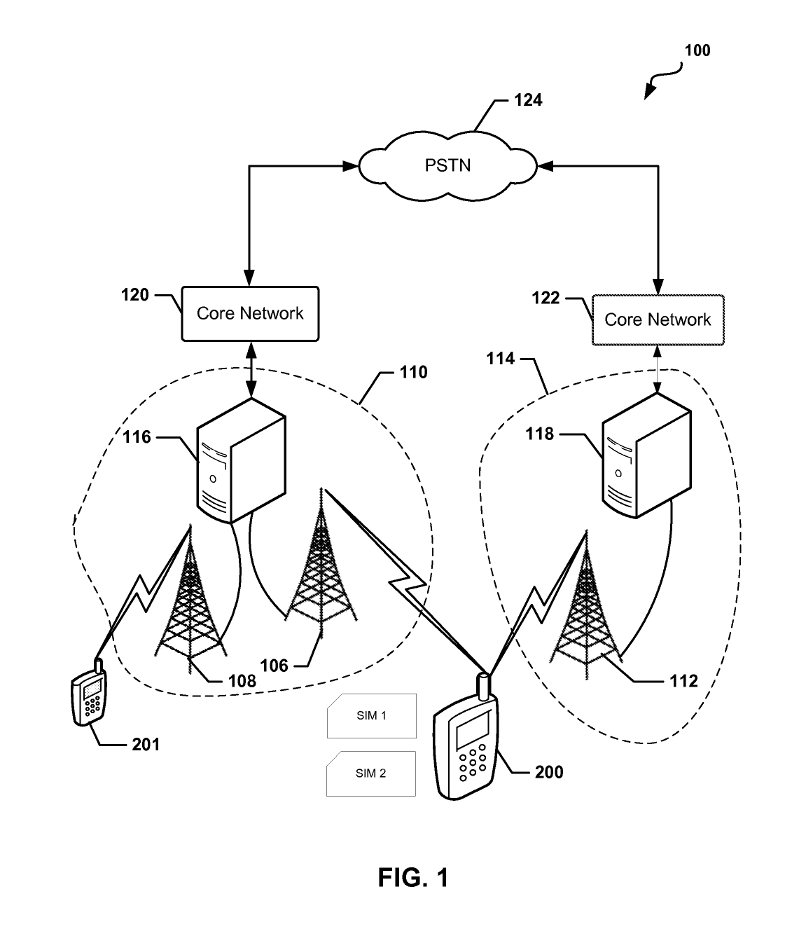

FIG. 1 illustrates a wireless network 100 suitable for use with various embodiments. Wireless devices 200, 201 may be configured to establish wireless connections with cell towers or base stations of one or more radio access networks. For example, the wireless devices 200, 201 may transmit/receive data using base stations 106, 108, which may be part of a network 110, as is known in the art. The wireless device 200 may further be configured to transmit/receive data through base station 112, which may be part of a different network 114.

The networks 110, 114 may be cellular data networks, and may use channel access methods including, but not limited to, Frequency Division Multiple Access (FDMA), Time Division Multiple Access (TDMA), Code Division Multiple Access (CDMA), UMTS (particularly, Long Term Evolution (LTE)), Global System for Mobile Communications (GSM), Wi-Fi, PCS, G-3, G-4, or other protocols that may be used in a wireless communications network or a data communications network. The networks 110, 114 may use the same or different wireless interfaces and/or physical layers. In some embodiments, the base stations 106, 108, 112 may be controlled by one or more base station controllers (BSC) 116, 118. For example, the base stations 106, 108, BSC 116, and other components may form the network 110, as is known in the art. Alternate network configurations may also be used and the embodiments are not limited to the configuration illustrated. For example, in another embodiment the functionality of the BSC 116 and at least one of the base stations 106, 108 may be collapsed into a single “hybrid” module having the functionality of these components.

In various embodiments, the wireless device 200 may simultaneously access core networks 120, 122 after camping on cells managed by the base stations 106, 112. The wireless device 200 may also establish connections with Wi-Fi access points, which may connect to the Internet. While various embodiments are particularly useful with wireless networks, the embodiments are not limited to wireless networks and may also be implemented over wired networks with no changes to the methods.

In the wireless network 100, the wireless device 200 may be a multi-SIM device that is capable of operating on a plurality of SIMs. For example, the wireless device 200 may be a dual-SIM device. Using dual-SIM functionality, the wireless device 200 may simultaneously access the two core networks 120, 122 by camping on cells managed by base stations 106, 112. The core networks 120, 122 may be interconnected by public switched telephone network (PSTN) 124, across which the core networks 120, 122 may route various incoming and outgoing communications to the wireless device 200.

The wireless device 200 may make a voice or data call to a third party device, such as the wireless device 201, using one of the SIMs. The wireless device 200 may also receive a voice call or other data transmission from a third party. The third party device (e.g., the wireless device 201) may be any of a variety of devices, including, but not limited to, a mobile phone, laptop computer, PDA, server, etc.).

Some or all of the wireless devices 200 may be configured with multi-mode capabilities and may include multiple transceivers for communicating with different wireless networks over different wireless links/radio access technologies (RATs). For example, the wireless device 200 may be configured to communicate over multiple wireless data networks on different subscriptions, such as in a dual-SIM wireless device. In particular, the wireless device 200 may be configured with dual-SIM dual active (DSDA) capability, which enables a dual-SIM device to simultaneously participate in two independent communications sessions, generally though independent transmit/receive chains.

For clarity, while the techniques and embodiments described herein relate to a wireless device configured with at least one GSM subscription, the techniques and embodiments described herein may be extended to subscriptions on other radio access networks (e.g., CDMA, UMTS, WCDMA, LTE, etc.).

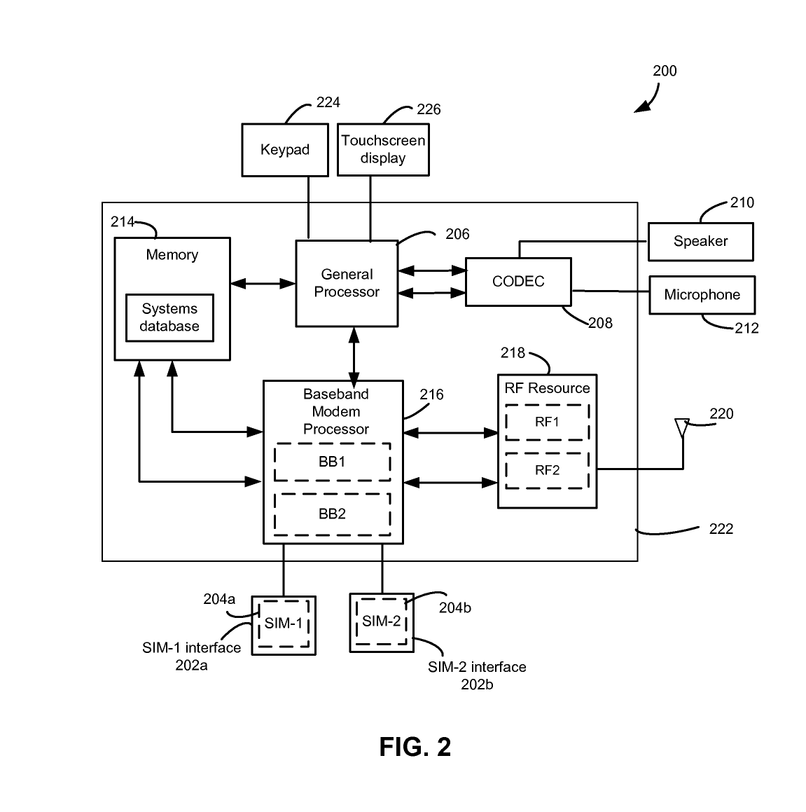

FIG. 2 is a functional block diagram of the wireless device 200 that is suitable for implementing various embodiments. With reference to FIGS. 1-2, the wireless device 200 may include a first SIM interface 202a, which may receive a first identity module SIM-1 204a that is associated with the first subscription. The wireless device 200 may also include a second SIM interface 202b, which may receive a second identity module SIM-2 204b that is associated with the second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store home identifiers (e.g., a System Identification Number (SID)/Network Identification Number (NID) pair, a Home Public-Land-Mobile-Network (HPLMN) code, etc.) to indicate the SIM card network operator provider. An Integrated Circuit Card Identity (ICCID) SIM serial number may be printed on the SIM card for identification.

The wireless device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions. The memory 214 may also store a systems database, which may contain a system preference lists (i.e., PRL or PLMN lists) and/or acquisition databases associated with the SIM-1 202a and the SIM-2 202b.

The general processor 206 and the memory 214 may each be coupled to at least one baseband modem processor 216. Each SIM in the wireless device 200 (e.g., the SIM-1 202a and the SIM-2 202b) may be associated with a baseband-RF resource chain. A baseband-RF resource chain may include the baseband modem processor 216, which may perform baseband/modem functions for communications on at least one SIM, and may further include one or more amplifiers and radios, referred to generally herein as RF resource 218. The RF resource 218 may perform transmit/receive functions for at least one SIM of the wireless device. In some embodiments, the RF resource 218 may include separate transmit and receive circuitry, or may include a transceiver that combines transmitter and receiver functions. The RF resource 218 may be coupled to a wireless antenna 220. While only the one wireless antenna 220 is shown, in some embodiments, the RF resource(s) may be coupled to a plurality of antennas (e.g., a first antenna and a second antenna). In various embodiments, the wireless antenna 220 may instead be multiple wireless antennas (e.g., a first wireless antenna and a second wireless antenna).

In various embodiments, the wireless device 200 may have a common baseband-RF resource chain for all SIMs in the wireless device 200 (i.e., the single baseband modem processor 216 and the single RF resource 218). Alternatively, different SIMs may be associated with separate baseband-RF resource chains that include physically or logically separate RF resources (i.e., RF1, RF2), each of which may be coupled to the common baseband modem processor 216 (i.e., a single device that performs baseband/modem functions for all SIMs on the wireless device 200). As a further alternative, different SIMs may be associated with separate baseband-RF resource chains that also include physically or logically separate baseband modem processors (e.g., BB1, BB2).

The at least one memory 214 of the wireless device 200 may store an operating system (OS) and user application software. In a particular embodiment, the general processor 206, the memory 214, the baseband processor(s) 216, and the RF resource 218 may be included in a system-on-chip device 222. The first and second SIMs 204a, 204b and the corresponding SIM interfaces 202a, 202b of the first and second SIMs 204a, 204b may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touch screen display 226.

In some embodiments, the keypad 224, the touch screen display 226, the microphone 212, or a combination thereof, may perform the function of receiving the request to initiate an outgoing call. For example, the touch screen display 226 may receive a selection of a contact from a contact list or receive a telephone number. In another example, either or both of the touch screen display 226 and the microphone 212 may perform the function of receiving a request to initiate an outgoing call. For example, the touch screen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

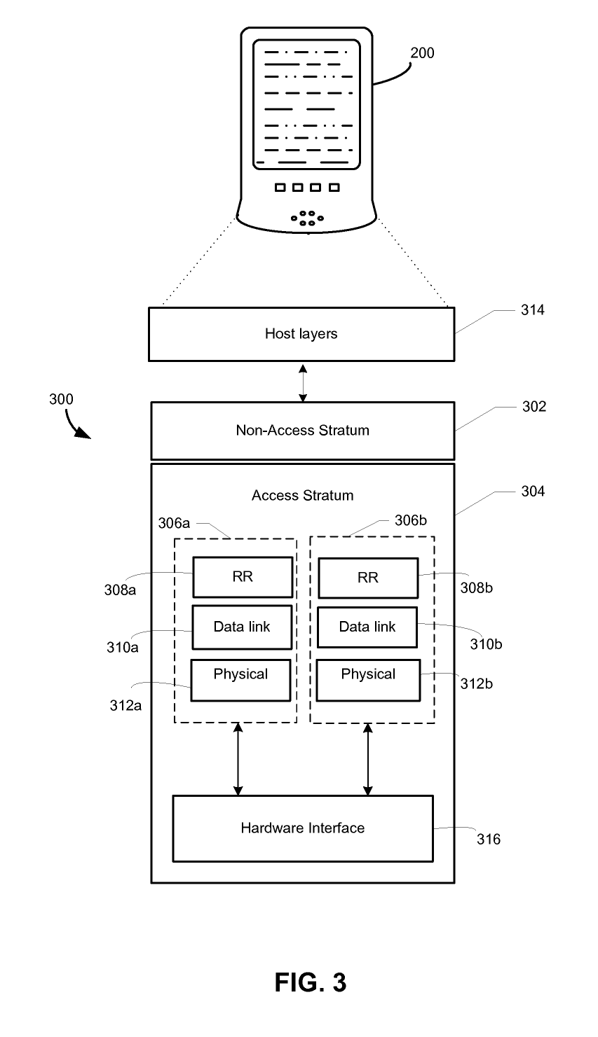

Referring to FIG. 3, the wireless device 200 may have a layered software architecture 300 to communicate over access networks associated with SIMs. The software architecture 300 may be distributed among one or more processors, such as the baseband modem processor 216 in FIG. 2. With reference to FIGS. 1-3, the software architecture 300 may also include a Non Access Stratum (NAS) 302 and an Access Stratum (AS) 304. The NAS 302 may include functions and protocols to support traffic and signaling between SIMs of the wireless device 200 (e.g., the SIM-1 204a and the SIM-2 204b) and the respective core networks of the SIMs. The AS 304 may include functions and protocols that support communication between the SIMs (e.g., the SIM-1 204a and the SIM-2 204b) and entities of the respective access networks of the SIMs (such as a Mobile Switching Station (MSC) if in a GSM network).

In the wireless device 200, the AS 304 may include multiple protocol stacks, each of which may be associated with a different SIM. For example, the AS 304 may include protocol stacks 306a, 306b (associated with the SIMs 208a, 208b, respectively). Although described with reference to GSM-type communication layers, the protocol stacks 306a, 306b may support any of variety of standards and protocols for wireless communications. Each of the protocol stacks 306a, 306b may respectively include Radio Resource management (RR) layers 308a, 308b. The RR layers 308a, 308b may be part of Layer 3 of a GSM signaling protocol, and may oversee the establishment of a link between the wireless device 200 and associated wireless networks. In various embodiments, the NAS 302 and the RR layers 308a, 308b may perform the various functions to search for wireless networks (i.e., “scan”) and to establish, maintain and terminate service.

In some embodiments, each of the RR layers 308a, 308b may be one of a number of sub-layers of Layer 3. Other sub-layers may include, for example, connection management (CM) sub-layers (not shown) that route calls, select a service type, prioritize data, perform QoS functions, etc.

Residing below the RR layers 308a, 308b, the protocol stacks 306a, 306b may also include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure the incoming data has been successfully received. In some embodiments, each of the data link layers 310a, 310b may contain various sub-layers (e.g., media access control (MAC) and logical link control (LLC) layers (not shown)). Residing below the data link layers 310a, 310b, the protocol stacks 306a, 306b may also include physical layers 312a, 312b, which may establish connections over the air interface and manage network resources for the wireless device 200.

While the protocol stacks 306a, 306b provide functions to transmit data through physical media, the software architecture 300 may further include at least one host layer 314 to provide data transfer services to various applications in the wireless device 200. In some embodiments, application-specific functions provided by the at least one host layer 314 may provide an interface between protocol stacks 306a, 306b and the general processor 202. In other embodiments, the protocol stacks 306a, 306b may each include one or more higher logical layers (e.g., transport, session, presentation, application, etc.) that provide host layer functions. In some embodiments, the software architecture 300 may further include in the AS 304 a hardware interface 316 between the physical layers 312a, 312b and the communication hardware (e.g., one or more RF transceivers).

Various embodiments may provide increased efficiency to the service acquisition process by sharing information across the modem stacks of the multiple SIMs. Specifically, since SIMs of a single wireless device are necessarily located in the same geographical area, acquisition of service on one SIM may provide a good indicator that other out-of-service SIMs on the wireless device may now be able to acquire service on a wireless network. Further, although multiple SIMs may be out-of-service, the sleep cycles of the multiple out-of-service SIMs may not be synchronized. For example, the SIMs may be in service on different networks, and may lose service at different times due to differences in coverage. In another example, each radio access technology may provide a different amount of time for attempting to again camp on the same wireless network before returning an out-of-service state to the wireless device processor. In another example, in a wireless device that has a common RF resource for multiple SIMs (e.g., a DSDS device), only one modem stack at a time may use the RF resource to try to acquire service. Therefore, once the wireless device is powered on and a first SIM begins using the RF resource to attempt service acquisition, the remaining SIM(s) may be out-of-service based on not being able to use the radio, followed by the first SIM if acquisition is not successful.

In various embodiments, once a first SIM in the power save mode is able to acquire service on a wireless network, other SIMs that are in the power save mode may be prompted to begin awake periods immediately and to perform searches for service signals as described. In this manner, acquisition may be optimized since other SIMs may be in the deep sleep periods of sleep cycles, and would ordinarily not search for service until expiration of the preset timer for the deep sleep period.

Example multi-SIM wireless devices that may implement various embodiments include those configured with independent radios associated with each SIM modem stack (e.g., DSDA devices) and those in which multiple SIMs share a RF resource (e.g., DSDS devices). In a DSDS device, for example, various embodiments may provide additional benefit in that a first SIM may acquire service by camping in idle mode (or in a limited service state), which may trigger the second SIM to begin its awake state in power save mode, and may allow the second SIM immediate control over the shared RF resource by virtue of the processor having already stopped the search for service signals associated with the first SIM.

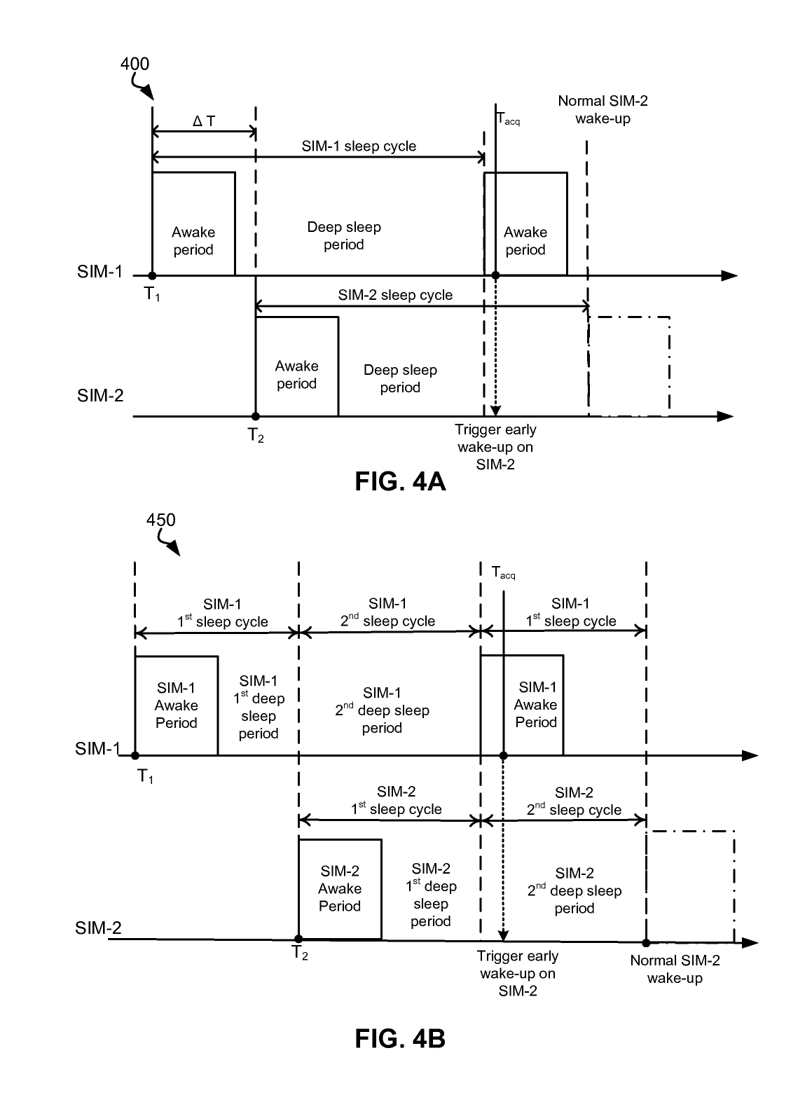

FIG. 4A shows an example optimized service acquisition timeline from power save mode on a dual-SIM wireless device, such as the wireless device 200 (e.g., refer to FIGS. 1-3). In this example, at times T1 and T2, SIM-1 and SIM-2 may enter a power save mode as a result of respectively going out-of-service. For example, out-of-service conditions may be the result of initial power up of the wireless device and/or losing service in the idle or active modes and failing to re-acquire the serving cell within the time specified by a communications protocol (e.g., 12 seconds in the idle mode for 3GPP). In this example, a delay between the power save mode start times T1 and T2 may equal ΔT. The start times T1 and T2 also correspond to a beginning of a first sleep cycle for SIM-1 and SIM-2, respectively.

In various embodiments, the SIM-1 sleep cycle and the SIM-2 sleep cycle each start with an awake period followed by a deep sleep period. In various embodiments, during the awake period on SIM-1, a processor (e.g., general processor 206) of the wireless device may attempt to acquire full service on a wireless network, followed by an attempt to acquire limited service if full service is unavailable. If at the end of the awake period no service has been acquired, SIM-1 may begin the deep sleep period of its sleep cycle, which may last for 30, 45, or 60 seconds (or other suitable period) in various embodiments. If at the end of the deep sleep period the processor has not otherwise removed SIM-1 from the SIM-1 power save mode, the SIM-1 sleep cycle will repeat. Meanwhile, during the awake period on SIM-2, the processor of the wireless device may attempt to acquire full or limited service on another wireless network, and if unsuccessful may enter the deep sleep period of its sleep cycle on SIM-2. Similar to the period of the SIM-1 sleep cycle, the deep sleep period of SIM-2 may also last for 30, 45, or 60 seconds. Also similar to SIM-1, if at the end of the deep sleep period of SIM-2 the processor has not otherwise removed SIM-2 from the SIM-2 power save mode, the SIM-2 sleep cycle will repeat. Although the durations of the sleep cycles for SIM-1 and SIM-2 may be equal, the sleep cycles for SIM-1 and SIM-2 may be offset in time. In this way, the awake periods for SIM-1 and SIM-2 do not overlap in time, even though the power save modes for SIM-1 and SIM-2 do overlap in time.

In various embodiments, once SIM-1 succeeds in acquiring service during an awake period, such as at Tacq, any remaining SIMs still in power save mode, such as SIM-2, may be triggered to attempt to acquire service prior to expiration of the deep sleep periods of the remaining SIMs still in power save mode. That is, various embodiments optimize recovery on multiple SIMs by taking advantage of a co-location of the multiple SIMs to predict similar ability to acquire or reacquire service. Thus, although Tacq is a point in time occurring in the middle of the deep sleep period on SIM-2, information corresponding to the acquisition of service by SIM-1 may be used to trigger an early wake-up on SIM-2. The early wake-up may remove SIM-2 from the deep sleep state in order to attempt to acquire service. In this way, rather than having SIM-2 wait until the normal SIM-2 wake-up time associated with the start of the next SIM-2 sleep cycle, the processor may initiate immediate attempts for acquisition of service for SIM-2.

In some embodiments, the conventional power save mode, which may be optimized, involves interleaved sleep cycles. In various embodiments, the term “interleaved” refers to mixing timing of events, such as cycles or periods, in an alternating pattern. For example, each SIM may be configured to use more than one type of sleep cycle, in which a first sleep cycle includes the awake period, and a second sleep cycle does not include the awake period. The first and second sleep cycles of the respective SIMs may be coordinated so that the SIMs alternate sleep cycles that include the awake period. In this way, the respective awake periods and the sleep cycles that include the awake periods may be interleaved so both SIMs do not have overlapping awake periods. Such interleaved sleep cycles and/or awake periods may be particularly suited to a wireless device in which the SIMs share a single RF resource (e.g., DSDS devices) since only one modem stack may search for service signals at a time, thereby creating a problem if the SIMs have overlapping awake periods. A first SIM and a second SIM may each separately operate in a power save mode that includes a plurality of deep sleep periods. In addition, the first SIM deep sleep periods may be interleaved with the second SIM deep sleep periods so the respective awake periods do not interfere with one another. In this way, the first SIM and the second SIM may take alternating turns of either awake periods or sleep cycles that include the awake periods when the first SIM and the second SIM are both in power save mode.

FIG. 4B shows an example of a service acquisition timeline 450 for interleaved sleep cycles on a dual-SIM wireless device, such as the wireless device 200 (e.g., refer to FIGS. 1-3). In this example, SIM-1 and SIM-2 may enter a power save mode at times T1 and T2, respectively, but the different sleep cycles of SIM-1 and SIM-2 may be synchronized, such as by the processor or a controller (not shown) in the wireless device. In this example, SIM-1 is associated with a SIM-1 first sleep cycle that includes the awake period, followed by a SIM-1 second sleep cycle that does not include the awake period. Similarly, SIM-2 is associated with the second SIM first sleep cycle that includes the awake period, followed by the second SIM second sleep cycle that does not include the awake period. The processor of the wireless device may schedule the SIM-1 second sleep cycle (that does not include an awake period) to coincide with the SIM-2 first sleep cycle (that includes the second SIM awake period). In addition, the SIM-2 second sleep cycle (that does not include an awake period) may coincide with the SIM-1 first sleep cycle (that includes a SIM-1 awake period). That is, the awake periods of SIM-1 and SIM-2 may be configured to occur on alternating synchronized sleep cycles (i.e., interleaved). In some embodiments, during an awake period on SIM-1 the wireless device may acquire service at time Tacq. The processor of the wireless device may trigger SIM-2 to wake-up at or near Tacq. As shown in the optimized service acquisition timeline 450, in a conventional service acquisition system, in which the sleep cycles have interleaved awake periods, the processor would wait until the normal SIM-2 wake-up time at the end of the SIM-2 second deep sleep period to have SIM-2 start the SIM-2 awake period.

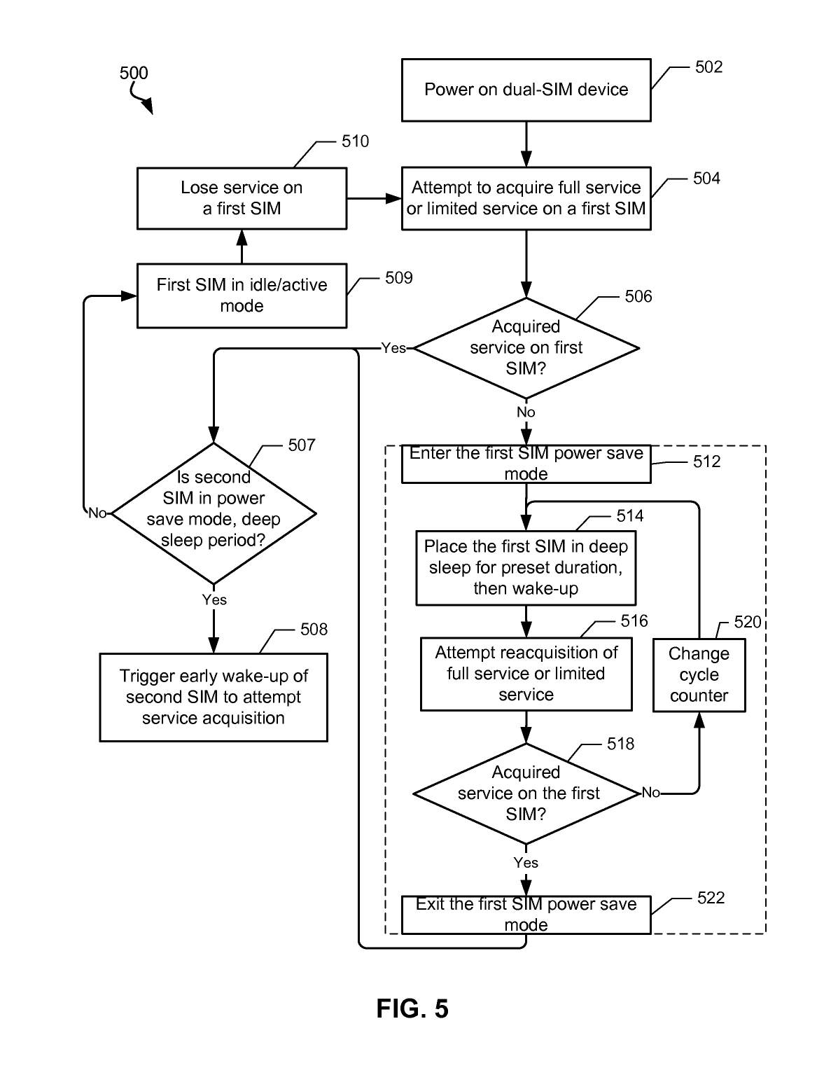

FIG. 5 illustrates a method 500 for optimizing service acquisition on a dual-SIM wireless device (e.g., 200 in FIGS. 1-3) in which the SIMs may operate in power save modes according to embodiments. The operations of method 500 may be implemented by one or more processors of the wireless device, such as the general processor 206 in FIG. 2, or a separate controller (not shown) that may be coupled to memory and to baseband modem processor(s) 216 in FIG. 2.

With reference to FIGS. 1-5, while described with respect to a dual-SIM wireless device, the operations of method 500 may be implemented by a multi-SIM wireless device having more than two SIMs (e.g., tri-SIM device, quad-SIM device, etc.), as will be appreciated by one of skill in the art. In the dual-SIM wireless device of method 500, the SIM to first acquire service (full or limited) is referred to as the “first SIM,” and the other SIM is referred to as the “second SIM.” In this way, while both SIMs (e.g., 204a, 204b) may separately attempt to acquire service in or out of the power save mode, the SIM that first acquires service may trigger the other SIM to attempt service acquisition earlier than that other SIM otherwise would. Thus, the references to first SIM and second SIM are arbitrary and refer only to a sequence in which the SIMs attempt to acquire service. Thus, the first SIM at one moment may become the second SIM for purposes of the embodiment descriptions. Therefore, references to “first SIM” and “second SIM” in the descriptions and the claims are not intended to refer to a particular in all instances.

In block 502, the wireless device may be initially powered on. In block 504, the wireless device processor may attempt to acquire service (full service or limited service) on one of the SIMs (i.e., a first SIM) by performing a service signal search to find suitable or acceptable cells as described.

In determination block 506, the wireless device processor may determine whether the first SIM has acquired full or limited service with a first wireless network. If full or limited service was acquired (i.e., determination block 506=“Yes”), the wireless device processor may determine whether the second SIM (or, if more than two SIMs, whether any other SIM) is presently operating in a deep sleep period as part of a second SIM power save mode, in determination block 507. If the wireless device processor determines that the second SIM is in the deep sleep period as part of the second SIM power save mode (i.e., determination block 507=“Yes”), in block 508 the wireless device processor may trigger a notification to the modem stack of the second SIM to cause an early wake-up of the second SIM (i.e., prematurely end the deep sleep period and operate in an awake state), regardless of whether the timer may not yet have expired for the deep sleep period of the second SIM power save mode. Once operating in the awake state in response to triggering the second SIM to do so, the processor may connect the second SIM to a select wireless network if an appropriate service signal is detected. If the processor does not detect an appropriate service signal within a predetermined period, the processor may initiate another second SIM power save mode, deep sleep period or simply resume the interrupted power save mode in which the second SIM was operating. In this way, when triggering the second SIM to operate in an awake state to acquire service, the processor may maintain the second SIM in the second SIM power save mode and the associated sleep cycle.

If the wireless device processor determines that the second SIM is not in a deep sleep period as part of the second SIM power save mode (i.e., determination block 507=“No”), the wireless device processor may camp the first SIM in idle mode or actively communicate in active mode on a cell of the acquired service in block 509. In block 510, the wireless device may detect the first SIM is out-of-service, from which the wireless device processor may return to block 504 and proceed in the same manner as if the device was powered on.

If the wireless device is unable to acquire full or limited service on the first SIM (i.e., determination block 506=“No”), the wireless device processor may set the modem stack of the first SIM to operate in (i.e., enter) the first SIM power save mode in block 512. Operating in the first SIM power save mode causes the modem stack associated with the respective out-of-service SIM to cycle between periods of deep sleep (low power usage) and attempting to acquire full or limited service on a wireless network (higher power usage). With each passing cycle or sets of cycles (e.g., every 10 cycles), a duration of the deep sleep periods may change (e.g., 30 seconds, 45 seconds, 60 second, etc.). In this way, a counter (e.g., block 520) may be used to track the cycles, which may be either reset when entering the first SIM power save mode, in block 512, and/or when exiting the first SIM power save mode, in block 522.

Once operating in the first SIM power save mode, in block 514 the wireless device processor may initiate a deep sleep period on the first SIM for a preset time duration, after which the first SIM may operate in an awake state for an awake period (i.e., forming a sleep cycle). As described, the deep sleep period of the first SIM power save mode may save battery power by, among other functions, refraining from performing any service signal searches for the first SIM. As also described, such deep sleep period may last, for example, for 30 seconds, 45 seconds, 60 seconds, or other preset amount of time, which may increase to a limit with each cycle or following a certain number of sets of cycles. For example, the preset time may change such that the first ten cycles may have deep sleep periods of 30 seconds, the second ten cycles may have deep sleep periods of 45 seconds, and the subsequent cycles may have deep sleep periods of 60 seconds. Following expiration of the preset time for the respective cycle, in block 516 the modem stack of the first SIM may operate in an awake state for an awake period in which the modem stack may again attempt acquisition of service on the first SIM with a wireless network.

In determination block 518, the wireless device processor may determine whether the first SIM has acquired full or limited service with a wireless network during the awake period. In this way, the determination as to whether the first SIM has acquired full or limited service may be in response to waking from the deep sleep period of block 514. If the wireless device acquires full or limited service on the first SIM during the awake period (i.e., determination block 518=“Yes”), the wireless device processor may set the modem stack of the first SIM to exit the first SIM power save mode in block 522. Exiting the first SIM power save mode may reset the power save mode counter. Once the first SIM is no longer in the first SIM power save mode, the wireless device processor may determine whether the second SIM (or another SIM) is presently operating in the deep sleep state of the deep sleep period and may benefit from notification of the service acquisition on the first SIM in determination block 507. If full or limited service is not acquired (i.e., determination block 518=“No”), the wireless device processor may change the cycle counter in block 520 and repeat the deep sleep and awake periods of continuing sleep cycles in the first SIM power save mode in block 514. In block 520, changing the cycle counter may track the number of cycles in the first SIM power save mode, which may be used to adjust the preset time duration of the deep sleep period for the respective cycle. In this way, the duration of at least one of the first SIM deep sleep periods may be based on how long the first SIM has been out-of-service. An incrementing, a decrementing, or other counter may be used (i.e., changed) to track cycles.

As discussed, the references to the first SIM and the second SIM, as well as to a first network, second network, etc., are arbitrary, and may apply to either or any SIM (e.g., 204a, 204b) and/or network of the wireless device.

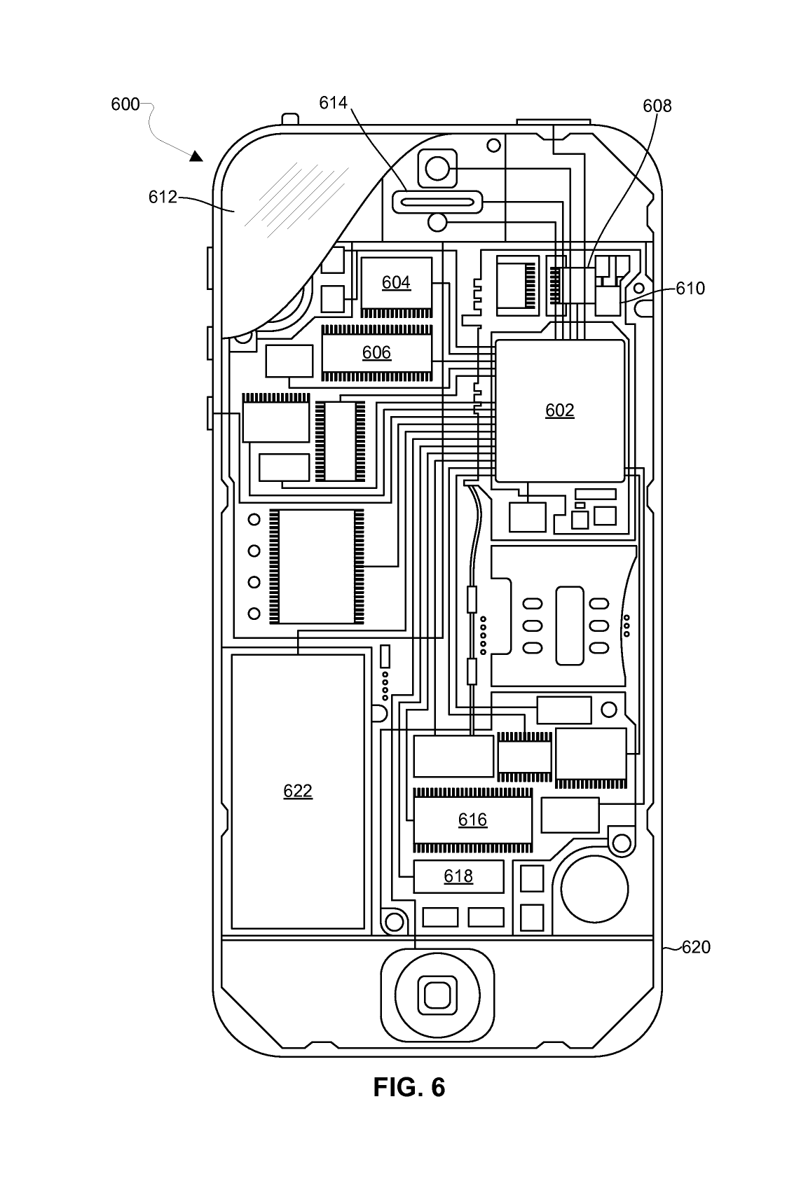

Various embodiments may be implemented in any of a variety of wireless devices 200, an example of which is illustrated in FIG. 6. For example, a wireless device 600 may include a processor 602 coupled to a touch screen controller 604 and an internal memory 606. The processor 602 may be one or more multi-core ICs designated for general or specific processing tasks. The internal memory 606 may be volatile or non-volatile memory, and may also be secure and/or encrypted memory, or unsecure and/or unencrypted memory, or any combination thereof.

The touch screen controller 604 and the processor 602 may also be coupled to a touch screen panel 612, such as a resistive-sensing touch screen, capacitive-sensing touch screen, infrared sensing touch screen, etc. The wireless device 600 may have one or more radio signal transceivers 608 (e.g., Peanut®, Bluetooth®, Zigbee®, Wi-Fi, RF radio) and antennae 610, for sending and receiving, coupled to each other and/or to the processor 602. The radio signal transceivers 608 and antennae 610 may be used with the above-mentioned circuitry to implement the various wireless transmission protocol stacks and interfaces. The wireless device 600 may include a cellular network wireless modem chip 616 that enables communication via a cellular network and is coupled to the processor. The wireless device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The wireless device 600 may also include speakers 614 for providing audio outputs. The wireless device 600 may also include a housing 620, constructed of a plastic, metal, or a combination of materials, for containing all or some of the components discussed herein. The wireless device 600 may include a power source 622 coupled to the processor 602, such as a disposable or rechargeable battery. The rechargeable battery may also be coupled to the peripheral device connection port to receive a charging current from a source external to the wireless device 600.

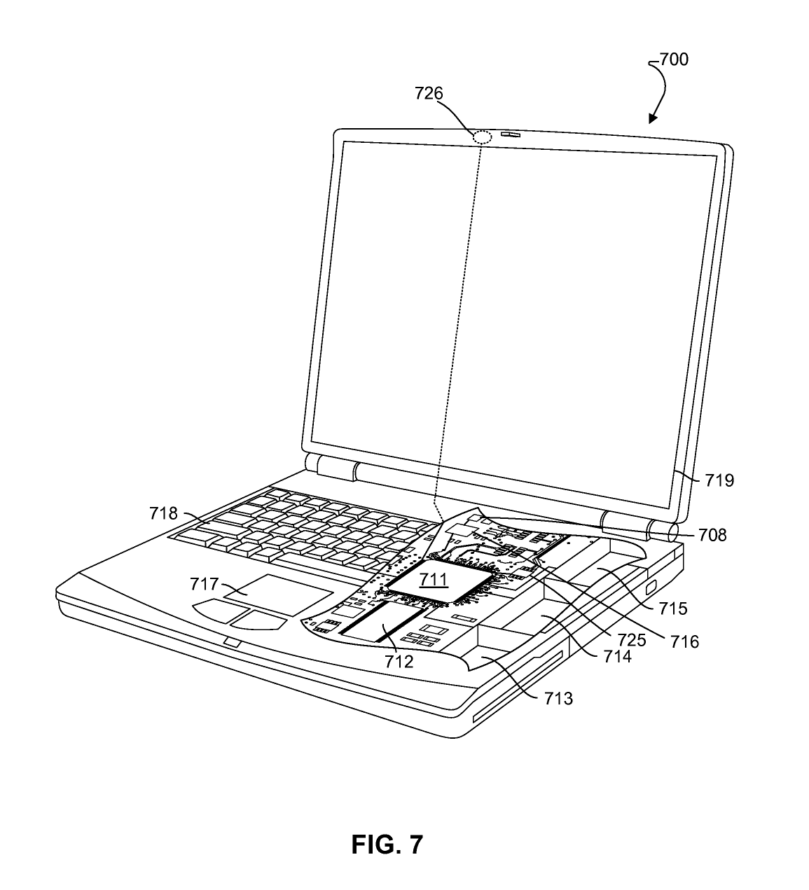

Various embodiments may also be implemented within a variety of personal computing devices (wireless devices 200), such as a laptop computer 700 as illustrated in FIG. 7. Many laptop computers include a touch pad touch surface 717 that serves as the computer's pointing device, and thus may receive drag, scroll, and flick gestures similar to those implemented on wireless computing devices equipped with a touch screen display and described. The laptop computer 700 will typically include a processor 711 coupled to volatile memory 712 and a large capacity nonvolatile memory, such as a disk drive 713 of Flash memory. The laptop computer 700 may also include a floppy disc drive 714 and a compact disc (CD) drive 715 coupled to the processor 711. The laptop computer 700 may also include a number of connector ports coupled to the processor 711 for establishing data connections or receiving external memory devices, such as a USB or FireWire® connector sockets, or other network connection circuits for coupling the processor 711 to a network. In a notebook configuration, the computer housing includes the touch pad touch surface 717, a keyboard 718, and a display 719 all coupled to the processor 711. Other configurations of the computing device may include a computer mouse or trackball coupled to the processor (e.g., via a USB input) as are well known, which may also be use in conjunction with various embodiments.

With examples referring to FIGS. 6 and 7 respectively, the processors 602 and 711 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 606, 712, and 713 before the software applications are accessed and loaded into the processors 606 and 711. The processors 606 and 711 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 606, 711, including internal memory or removable memory plugged into the device and memory within the processor 606 and 711, themselves.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of the functionality of those components, blocks, modules, circuits, and steps. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of acquiring wireless network service on a wireless device having a first subscriber identification module (SIM) and a second SIM, comprising:
determining whether the first SIM has acquired a first service with a first wireless network while the second SIM is operating in a second SIM deep sleep period; and
triggering the second SIM to operate in an awake state, prior to expiration of the second SIM deep sleep period, to acquire a second service with a second wireless network in response to determining that the first SIM has acquired the first service with the first wireless network.

2. The method of claim 1, wherein determining whether the first SIM has acquired the first service with the first wireless network comprises determining that the first SIM has acquired the first service with the first wireless network when the acquired first service is a most recently lost service of the first SIM.

3. The method of claim 1, wherein determining whether the first SIM has acquired the first service with the first wireless network comprises determining that the first SIM has acquired the first service with the first wireless network when the acquired first service is a limited service.

4. The method of claim 1, wherein:
the second SIM deep sleep period is part of a second SIM power save mode; and
the method further comprises maintaining the second SIM in the second SIM power save mode in response to not acquiring the second service with the second wireless network.

5. The method of claim 1, wherein:
the second SIM deep sleep period is part of a second SIM power save mode that includes a second SIM first sleep cycle and a second SIM second sleep cycle; and
one of the second SIM first sleep cycle and the second SIM second sleep cycle does not include a second SIM awake period.

6. The method of claim 1, wherein determining whether the first SIM has acquired the first service with the first wireless network is performed in response to the first SIM waking from a first SIM deep sleep period.

7. The method of claim 1, wherein during the second SIM deep sleep period, the second SIM refrains from attempting acquisition of the second service and power is shut off from non-essential circuitry associated with the second SIM.

8. The method of claim 1, wherein triggering the second SIM to operate in the awake state to acquire the second service with the second wireless network comprises:
detecting a service signal of a most recently lost service of the second SIM corresponding to the second wireless network; and
connecting the second SIM to the second wireless network using the service signal.

9. The method of claim 1, further comprising:
connecting the second SIM to the second wireless network in response to triggering the second SIM to operate in the awake state to acquire the second service.

10. The method of claim 1, wherein determining whether the first SIM has acquired the first service with the first wireless network while the second SIM is operating in the second SIM deep sleep period comprises:
determining whether the second SIM is operating in the second SIM deep sleep period.

11. The method of claim 1, further comprising;
setting the first SIM to operate in a first SIM power save mode including a first SIM deep sleep period in response to determining that the first SIM is out-of-service;
connecting the first SIM to the first wireless network during a first SIM awake period of the first SIM power save mode; and
determining that the first SIM has acquired the first service with the first wireless network in response to connecting the first SIM to the first wireless network.

12. The method of claim 11, wherein a duration of at least one of the first SIM deep sleep period and the second SIM deep sleep period is based on how long the first SIM and the second SIM respectively have been out-of-service.

13. The method of claim 11, wherein connecting the first SIM to the first wireless network comprises:
detecting a first service signal;
attempting to acquire full service using the first service signal;
determining whether full service was acquired using the first service signal;
detecting a second service signal in response to determining that full service was not acquired using the first service signal; and
attempting to acquire limited service using the second service signal.

14. The method of claim 11, further comprising:
setting the second SIM to operate in a second SIM power save mode including the second SIM deep sleep period and a second SIM awake period in response to determining that the second SIM is out-of-service;
wherein the first SIM awake period and the second SIM awake period are interleaved to not overlap in time.

15. The method of claim 11, further comprising:
setting the second SIM to operate in a second SIM power save mode including the second SIM deep sleep period in response to determining that the second SIM is out-of-service;
wherein there is at least a partial overlap in time during which the first SIM operates in the first SIM power save mode and the second SIM operates in the second SIM power save mode.

16. The method of claim 15, wherein:
the first SIM power save mode includes a first SIM first sleep cycle and a first SIM second sleep cycle, wherein the first SIM second sleep cycle does not include the first SIM awake period; and
the second SIM power save mode includes a second SIM first sleep cycle and a second SIM second sleep cycle, wherein the second SIM second sleep cycle does not include a second SIM awake period, wherein the first SIM second sleep cycle and the second SIM second sleep cycle do not overlap in time.

17. A wireless device, comprising:
at least one radio frequency (RF) resource; and
a processor coupled to the at least one RF resource and configured to be coupled to a first subscriber identification module (SIM) and a second SIM, wherein the processor is configured with processor executable instructions to:
determine whether the first SIM has acquired a first service with a first wireless network while the second SIM is operating in a second SIM deep sleep period; and
trigger the second SIM to operate in an awake state, prior to expiration of the second SIM deep sleep period, to acquire a second service with a second wireless network in response to determining that the first SIM has acquired the first service with the first wireless network.

18. The wireless device of claim 17, wherein the processor is further configured with processor executable instructions to determine that the first SIM has acquired the first service with the first wireless network when the acquired first service is a most recently lost service of the first SIM.

19. The wireless device of claim 17, wherein the processor is further configured with processor executable instructions to determine that the first SIM has acquired the first service with the first wireless network when the acquired first service is a limited service.

20. The wireless device of claim 17, wherein the processor is further configured with processor executable instructions such that the second SIM deep sleep period is part of a second SIM power save mode, wherein the processor is further configured with processor executable instructions to:
maintain the second SIM in the second SIM power save mode in response to not acquiring the second service with the second wireless network.

21. The wireless device of claim 17, wherein the processor is further configured with processor executable instructions such that the second SIM deep sleep period is part of a second SIM power save mode that includes a second SIM first sleep cycle and a second SIM second sleep cycle, wherein one of the second SIM first sleep cycle and the second SIM second sleep cycle does not include a second SIM awake period.

22. The wireless device of claim 17, wherein the processor is further configured with processor executable instructions to determine whether the first SIM has acquired the first service with the first wireless network in response to the first SIM waking from a first SIM deep sleep period.

23. The wireless device of claim 17, wherein the processor is further configured with processor executable instructions to:
detect a first service signal;
attempt to acquire full service using the first service signal;
determine whether full service was acquired using the first service signal;
detect a second service signal in response to determining that full service was not acquired using the first service signal; and
attempt to acquire limited service using the second service signal.

24. The wireless device of claim 17, wherein the processor is further configured with processor executable instructions to:
set the first SIM to operate in a first SIM power save mode including a first SIM deep sleep period in response to determining that the first SIM is out-of-service;
connect the first SIM to the first wireless network during a first SIM awake period of the first SIM power save mode; and
determine that the first SIM has acquired the first service with the first wireless network in response to connecting the first SIM to the first wireless network.

25. The wireless device of claim 24, wherein the processor is further configured with processor executable instructions such that a duration of at least one of the first SIM deep sleep period and the second SIM deep sleep period is based on how long the first SIM and the second SIM respectively have been out-of-service.

26. The wireless device of claim 24, wherein the processor is further configured with processor executable instructions to:
set the second SIM to operate in a second SIM power save mode including the second SIM deep sleep period and a second SIM awake period in response to determining that the second SIM is out-of-service, wherein the first SIM awake period and the second SIM awake period are interleaved to not overlap in time.

27. The wireless device of claim 24, wherein the processor is further configured with processor executable instructions to:
set the second SIM to operate in a second SIM power save mode including the second SIM deep sleep period in response to determining that the second SIM is out-of-service, wherein there is at least a partial overlap in time during which the first SIM operates in the first SIM power save mode and the second SIM operates in the second SIM power save mode.

28. The wireless device of claim 27, wherein the processor is further configured with processor executable instructions such that the first SIM power save mode includes a first SIM first sleep cycle and a first SIM second sleep cycle, wherein the first SIM second sleep cycle does not include the first SIM awake period, and
wherein the processor is further configured with processor executable instructions such that the second SIM power save mode includes a second SIM first sleep cycle and a second SIM second sleep cycle, wherein the second SIM second sleep cycle does not include a second SIM awake period, wherein the first SIM second sleep cycle and the second SIM second sleep cycle do not overlap in time.

29. A wireless device, comprising:
means for determining whether a first subscriber identification module (SIM) has acquired a first service with a first wireless network while a second SIM is operating in a second SIM deep sleep period; and
means for triggering the second SIM to operate in an awake state, prior to expiration of the second SIM deep sleep period, to acquire a second service with a second wireless network in response to determining that the first SIM has acquired the first service with the first wireless network.

30. A non-transitory processor-readable storage medium having stored thereon processor-executable instructions configured to cause a processor to perform operations for acquiring wireless network service on a wireless device, the operations comprising:
determining whether a first subscriber identification module (SIM) has acquired a first service with a first wireless network while a second SIM is operating in a second SIM deep sleep period; and
triggering the second SIM to operate in an awake state, prior to expiration of the second SIM deep sleep period, to acquire a second service with a second wireless network in response to determining that the first SIM has acquired the first service with the first wireless network.
